(19) United States
(12) Patent Application Publication
(10) Pub. No.: US 2023/0114266 A1
(43) Pub. Date: Apr. 13, 2023

(54) Processing data anonymously

(71) Applicant: REVEAL TECHNOLOGY GROUP LTD, Stockton On Tees (GB)

(72) Inventor: Trevor Andrew Clark, Bracknell (GB)

(21) Appl. No.: 17/801,969

(22) PCT Filed: Mar. 5, 2021
(86) PCT No.: PCT/EP2021/055671

§ 371 Date: Aug. 24, 2022

(30) Foreign Application Priority Data
Mar. 6, 2020 (GB) 2003283.5

(51) Int. Cl. G06F 21/62; G06Q 30/02

(52) U.S. Cl. CPC G06F 21/6254; G06Q 30/0251

(57) ABSTRACT

A data processing system comprises a client system, comprising at least one client dataset having transactional data and customer data, a provider system, separate from the client system, and comprising an analysis engine and an action engine, wherein the analysis engine is adapted to request transactional data from the client system, on receipt of such a request, the client system is adapted to send a dataset containing transaction data linked to anonymised customer identification codes, not including customer contact information, on receipt of the dataset, the analysis engine is adapted to perform an analysis of the transaction data and generate recommendations for customer engagement in relation to at least one customer identification code within the dataset, the provider system is adapted to then request from the client system customer contact information corresponding to the at least one customer identification code and, on receipt, pass this to the action engine but not the analysis engine, and the action engine is adapted to then (i) perform a customer engagement action using the recommendations and the customer contact information and (ii) delete the customer contact information.

### FIELD OF THE INVENTION

The present invention relates to methods, systems and apparatus for the processing of data in a genuinely anonymous manner.

### BACKGROUND ART

Data processing on behalf of third parties faces the intrinsic difficulty that the data in question is likely to be protected in a number of ways simultaneously. For example, in the case of an online vendor who holds data relating to their past transactions, some data is confidential to the vendor and some is private information relating to the vendor’s customers. The former is protected as confidential information, and the latter is protected by one or more of contractual relationships, confidentiality, and privacy laws such as the GDPR.

It is possible to ensure that a data processing system complies with these requirements, but this imposes a significant technical and management overhead. Creating a system that is compliant with the privacy laws of all major jurisdictions in which a client may be located and ensuring that it remains secure and compliant is a non-trivial task. In particular, some privacy laws (such as GDPR) prohibit transfer of private data outside the jurisdiction in which they were created; it only requires a few major jurisdictions to follow this lead and a centralised data processing system providing a service to multiple clients in multiple jurisdictions becomes legally impossible.

### SUMMARY OF THE INVENTION

One option is to limit the data that is received to a set that does not contain private customer information. If the data is not present, then the system retaining it does not need to be compliant. A leak of such data would be a breach of the client’s confidentiality, but this is more straightforward to guard against and the data handling processes can be agreed with the client. However, it is then impossible for the data processor to act on the insights gained from the data, as the means to contact the customers is absent.

The present invention therefore provides a data processing system, comprising a client system, comprising at least one client dataset having transactional data and customer data, a provider system, separate from the client system, and comprising an analysis engine and an action engine, wherein the analysis engine is adapted to request transactional data from the client system, on receipt of such a request, the client system is adapted to send a dataset containing transaction data linked to anonymised customer identification codes, not including customer contact information, on receipt of the dataset, the analysis engine is adapted to perform an analysis of the transaction data and generate recommendations for customer engagement in relation to at least one customer identification code within the dataset, the provider system is adapted to then request from the client system customer contact information corresponding to the at least one customer identification code and, on receipt, pass this to the action engine but not the analysis engine, and the action engine is adapted to then (i) perform a customer engagement action using the recommendations and the customer contact information and (ii) delete the customer contact information.

The provider system may be adapted to retain the transactional data after generating recommendations for customer engagement for use in a subsequent analysis, allowing subsequent deliveries of transactional data to be incremental rather than wholesale

The invention also relates to a corresponding method of data analysis.

Within that method, the data processing method preferably retains the transactional data received from the client system, and aggregates this for analysis by the analysis engine to measure a total engagement between the client and the customer represented by each customer identification code. This allows a consistent measurement of activity which can be used to allocate both rewards and content delivered to the customer.

It is advantageous to include the at least one customer identification code within the customer engagement action. Generally, the customer engagement action includes a message transmitted via an electronic means, which can then include an invitation to share the message in a form which preserves the customer identification code within the shared message and which is transmitted to the client system in the event of a purchase resulting from the shared message. In that case, the dataset containing transaction data and anonymised customer identification codes can also include the transmitted customer identification code, enabling the sharing to be taking into account in making recommendations for customer engagement in respect of the customer who shared the message.

### BRIEF DESCRIPTION OF THE DRAWINGS

An embodiment of the present invention will now be described by way of example, with reference to the accompanying figures in which;

FIG. 1 illustrates a logical methodology of the system and process according to the invention.

### DETAILED DESCRIPTION OF THE EMBODIMENTS

The present invention arises from a data processing need that is apparent in carrying out the analysis of customer transactional information for the purpose of encouraging customer engagement and further sales growth. An example of this is reward-based marketing, where customers with potential for further development are identified within the sales and transactional information of a particular vendor, and a reward of some sort is provided to the customer. The reward can be one of many forms; vouchers are well known as a form of reward and may be aimed at generation of additional sales or the promotion of cross-selling opportunities. Another form is reward-based games; a scratchcard- or draw-based game, for example, can be sent to customers as an attention-getting exercise which encourages them to participate.

A vendor will wish to maximise the performance of whatever strategy is adopted, and this will require the use of an optimised reward - i.e. one that is sufficient to gain the customer’s attention but not so generous that it impacts the vendor’s income. It also requires the identification of the correct customers, being those who are likely to respond. A particularly refined strategy will match the two, varying the reward to match the potential response of an individual customer. For example, a customer who has recently purchased travel insurance might be interested in foreign exchange services, or airport parking services, or other travel-related goods and services.

Regardless of the nature of the reward, the process of identifying the customers who should be approached in order to maximise the effect of the reward programme can be complex. Where the marketing service is being provided by an external agency on behalf of their client, i.e. the vendor, an additional concern arises in that the process or algorithm by which the customers and/or the appropriate reward are identified within the data is likely to be highly confidential. The service provider will not wish to disclose this to their client as the client would thereafter be able to carry out the data analysis themselves, so this process needs to be run on a server that is under the control of the provider not the client. However, the client holds the sales and transactional data that is needed for the algorithm to run, so this needs to be transferred to the provider.

As soon as plans are made to transfer this data from one entity to another, legal considerations such as the GDPR regulations come into play. At best, these require that the data recipient conform to the relevant legal standard. At worst, they may completely bar the data transfer, such as (for example) the transfer of data from an EU-resident business to a business resident outside the EU in a state whose data protection provisions do not meet EU standards. As a result, the service provider will need to establish a compliant data processing system, and accept legal responsibility for the maintenance of that system together with liability for any failures, or must accept that they cannot operate on behalf of that client.

This embodiment of the present invention provides and implements a data handling process which avoids this difficulty. It is not concerned with the nature of the algorithm that is being run on the data, or the purpose of the algorithm per se, and is therefore applicable regardless of the nature of these. Instead, given the externally-applied regulations for data handling, it aims to produce a technical structure for the data handling process that is both efficient and viable for use.

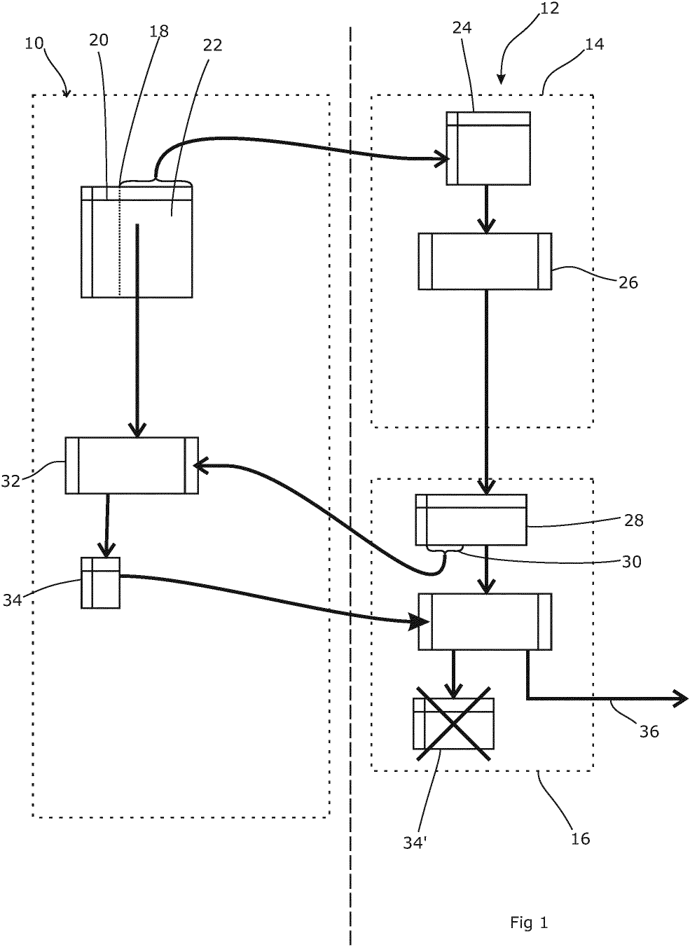

FIG. 1 illustrates the data handling process according to this invention. The scheme is divided into two domains, a client domain 10 that is under the control of the client whose data is to be processed, and a provider domain 12 which is under the control of the service provider. Within the provider domain, there is an analysis engine 14 and an action engine 16, which will be described in more detail below.

Within the client domain 10, the client holds their dataset 18 which contains records of the transactions with individual customers. Each record contains details 20 relating to the customer, such as their name and the contact details used for the order, and details 22 of the transaction such as the goods or services ordered, the order date, the order value, etc. An extract of this data is made, replacing the customer details 20 with a customer ID only and sending this transaction data 22 from the client domain 10 to the analysis engine 14 where it is retained as a working dataset 24. This contains no customer-identifying information; the only information is the transaction data 22 which is owned by the client (who has consented to this process by engaging the provider), and a customer ID which can be a simple alphanumeric code which is consistent and unique to that customer. In the absence of any private information belonging to customers, this transfer is outside the scope of data protection requirements.

The working dataset 24 is then processed by the provider’s proprietary algorithm 26. As noted above, the precise details of this algorithm are not relevant to the invention and will generally be proprietary and confidential, aimed at identifying business opportunities within the working dataset 24. The result of this analysis is a recommendation dataset 28 containing a list of customer codes and recommendations for engagement actions; this is passed to the action engine 16 which is logically, physically and/or operationally separate from the analysis engine 14.

The recommendation dataset 28 alone is insufficient to enable customer engagement processes to be initiated, as it does not include any means of contacting the customer, having been created by the analysis engine which did not have access to this information. The action engine therefore extracts the customer codes 30 from the recommendation dataset 28, being the codes associated with customers for whom an engagement action is recommended, and send these to the client system 32. Within the client domain 10, the customer contact details 34 corresponding to the customer codes 30 are extracted from the dataset 18 and sent to the analysis engine 16, where they are united with the recommendation dataset 28 to allow the recommendations to be put into effect. Customer engagement messages are then sent out at 36 and the copy of the customer contact details 34' held in the analysis engine 16 are deleted.

As the customer contact details are only held transiently and are not retained, the transfer is again not subject to data protection concerns as the provider does not ‘hold’ private customer data.

The customer code can be automatically assigned to each customer as a ‘Personalised Engagement Number’ (PEN) for each client of the provider at the point of transaction on the initial purchase. The PEN remains the customer identification during their lifetime purchases. Reward content can then be delivered to individual customers via digital media channel networks and delivery filtered accordingly. Rewards are linked to the PEN of each individual customer, allowing it and other predetermined metrics (including but not limited to Sales, Customer Lifetime Value and Shared Value) to determine both the odds and value of rewards.

Thus, the present invention allows the analysis of brand’s user sales data, and the ongoing storage of this data to provide a full and ongoing functionality; the PEN technology creates a unique process that allows the collection of user data without being compromised. A unique lifetime number (PEN), per customer is non-user-identifiable data and data can be stored against it. Once matched to a 3rd party client’s system alpha/numeric reference (such as an account number) the data can be married to the user, effectively creating a 2-factor process. As the process does not store User Identifiable Data information, it is unconditionally compliant with GDPR and the like and can never be data compromised.

A further development of the above process takes advantage of the fact that each customer within the client database has been assigned a unique identifier. Although that ‘identifier’ does not contain any information that (per se) allows the customer’ personal details to be determined, it is unique to that customer and allows the records held by the provider which relate to that customer (whoever they may be) to be correlated. Thus, in a preferred embodiment of the present invention, the identifier (or PEN) is included in some form within the customer engagement messages that are sent out by the action engine 16.

Generally, the customer engagement messages are transmitted via an electronic or online means. Often, they may include an invitation to share the message with those known to the customer such as friends, family and other contacts. When they share the message with friends and family, the PEN of the originating customer will then be included in the shared message, and if that contact takes up an invitation in the message then the originating PEN can be identified.

When the recipient of the shares message purchases or otherwise engages with the client’s systems, they will of course be allocated their own PEN, but (according to this embodiment of the invention) this new PEN is also linked to the PEN of the originating customer who provided them with the link, and included in future data transfers to the provider. The sales value associated with the new PEN (or part of it) can be assigned to the originator PEN, i.e. that of the customer who shared the message which led to the sale. The algorithm 26 can then allocate rewards (or the like) to the originating PEN based on this elevated sales value, thereby taking account of their value to the client as an influencer of others and encouraging such behaviour.

It will of course be understood that many variations may be made to the above-described embodiment without departing from the scope of the present invention.

1. A data processing system, comprising:
a client system, comprising at least one client dataset having transactional data and customer data
a provider system, separate from the client system, and comprising an analysis engine and an action engine; wherein:
the analysis engine is adapted to request transactional data from the client system,
on receipt of such a request, the client system is adapted to send a dataset containing transaction data linked to anonymised customer identification codes, not including customer contact information,
on receipt of the dataset, the analysis engine is adapted to perform an analysis of the transaction data and generate recommendations for customer engagement in relation to at least one customer identification code within the dataset,
the provider system is adapted to then request from the client system customer contact information corresponding to the at least one customer identification code and, on receipt, pass this to the action engine but not the analysis engine, and
the action engine is adapted to then (i) perform a customer engagement action using the recommendations and the customer contact information and (ii) delete the customer contact information.

2. TheA data processing system according to claim 1 in which the provider system is adapted to retain the transactional data after generating recommendations for customer engagement for use in a subsequent analysis.

3. A data processing method, implemented on a system including an analysis engine and a distinct action engine,
the method comprising:
requesting transactional data from a separate client system and delivering the transactional data to the analysis engine in the form of a dataset containing transaction data linked to anonymised customer identification codes, not including customer contact information,
performing an analysis of the transaction data using the analysis engine to generate recommendations for customer engagement in relation to at least one customer identification code within the dataset,
requesting from the client system customer contact information corresponding to the at least one customer identification code and, on receipt, delivering this to the action engine but not the analysis engine, and
via the action engine, (i) performing a customer engagement action using the recommendations and the customer contact information and (ii) deleting the customer contact information.

4. TheA data processing method according to claim 3 in which the transactional data received from the client system is aggregated and analysed by the analysis engine to measure a total engagement between the client and the customer represented by each customer identification code.

5. The data processing method according to claim 1 in which the at least one customer identification code is included within the customer engagement action.

6. TheA data processing method according to claim 5 in which the customer engagement action includes a message transmitted via an electronic means.

7. TheA data processing method according to claim 6 in which the message includes an invitation to share the message in a form which preserves the customer identification code within the shared message and which is transmitted to the client system in the event of a purchase resulting from the shared message.

8. TheA data processing method according to claim 7 in which the dataset containing transaction data and anonymised customer identification codes also includes the transmitted customer identification code.
